(19) United States
(12) Patent Application Publication
(10) Pub. No.: US 2024/0322725 A1
(43) Pub. Date: Sep. 26, 2024

(54) MOTOR CONTROLLER

(71) Applicant: DENSO CORPORATION, Kariya-city (JP)

(72) Inventor: YUSUKE SHIBATA, Kariya-city (JP)

(21) Appl. No.: 18/678,862

(22) Filed: May 30, 2024

Related U.S. Application Data
(63) Continuation of application No. PCT/JP2022/042568, filed on Nov. 16, 2022.

(30) Foreign Application Priority Data
Dec. 2, 2021 (JP) 2021-196167
Sep. 27, 2022 (JP) 2022-153875

(51) Int. Cl. H02P 21/22; H02P 21/18; H02P 21/20

(52) U.S. Cl. CPC H02P 21/22; H02P 21/18; H02P 21/20

(57) ABSTRACT

A motor controller includes a power converter and a current command calculator. The power converter supplies alternating current power to each phase of a multiphase motor by converting input power. The current command calculator calculates a current command value for a current supplied to the multiphase motor, the current command value being defined by a current amplitude and a current phase, the current command calculator executes a phase adjustment process in a case where the multiphase motor is in locking energization being a state in which the multiphase motor is being energized while the multiphase motor has stopped rotation, except when the multiphase motor satisfies a predetermined exemption condition. The phase adjustment process is a process in which the current phase of the current command value is changed over time to prevent the multiphase motor from being energized on same phase for a predetermined time or longer.

### CROSS REFERENCE TO RELATED APPLICATIONS

The present application is a continuation application of International Patent Application No. PCT/JP2022/042568 filed on Nov. 16, 2022, which designated the U.S. and claims the benefit of priority from Japanese Patent Application No. 2021-196167 filed on Dec. 2, 2021 and Japanese Patent Application No. 2022-153875 filed on Sep. 27, 2022. The entire disclosures of all of the above applications are incorporated herein by reference.

### TECHNICAL FIELD

The present disclosure relates to a motor controller.

### BACKGROUND

A motor controller may control a current to energize a multiphase motor.

### SUMMARY

The present disclosure describes a motor controller including a power converter and a current command calculator.

### BRIEF DESCRIPTION OF DRAWINGS

Objects, features and advantages of the present disclosure will become more apparent from the following detailed description made with reference to the accompanying drawings. In the drawings:

FIG. 1 illustrates a motor controller for a three-phase motor for an electric brake of a vehicle;

FIG. 2 is a schematic diagram of an electric brake for each wheel;

FIG. 3 is a block diagram illustrating a configuration example of a motor controller according to the present embodiment;

FIG. 4 is a current vector diagram showing a maximum efficiency operating point in the dq-axis coordinate system;

FIG. 5 is a diagram showing the relationship between a motor position (electrical angle) and a three-phase current when driven at the maximum efficiency operating point;

FIG. 6 is a time chart of three-phase currents when locking current is applied (stop position 30°);

FIG. 7 is a current vector diagram showing a phase adjustment process on an constant-torque curve according to a first embodiment;

FIG. 8 is a diagram showing a relationship between a phase angle and a three-phase current in the phase adjustment process (stop position 30°) of the first embodiment;

FIG. 9 is a time chart of three-phase currents during locking energization when the phase adjustment process (stop position 30°) of the first embodiment is performed;

FIG. 10 is a motor position-three-phase current diagram showing conditions A to D for the stop position;

FIG. 11 is a diagram showing the phase changing quantity vs. three-phase current's absolute value under condition A (stop position 30°);

FIG. 12 is a diagram showing the phase changing quantity vs. three-phase current's absolute value under condition B (stop position 40°);

FIG. 13 is a diagram showing the phase changing quantity vs. three-phase current's absolute value under condition C (stop position 17°);

FIG. 14 is a diagram showing the phase changing quantity vs. three-phase current's absolute value under condition D (stop position 5°);

FIG. 15 is a graph showing the phase changing quantity with respect to the three-phase current's absolute value under condition AA in which the torque is doubled compared to condition A;

FIG. 16 is a flowchart of the phase adjustment process;

FIG. 17 is a current vector diagram showing a phase adjustment process on a constant-amplitude circle according to a second embodiment;

FIG. 18 is a diagram showing a relationship between a phase angle and a three-phase current by a phase adjustment process according to the second embodiment;

FIG. 19 is a diagram showing a relationship between a phase angle and torque by the phase adjustment process according to the second embodiment;

FIG. 20A is a schematic diagram of an electric brake pad;

FIG. 20B is a characteristic diagram of a pad load and a pad position;

FIG. 21 is a diagram showing hysteresis characteristics of a motor torque and a pad load;

FIG. 22 is a current vector diagram illustrating a phase adjustment process according to a third embodiment; and

FIG. 23 is a flowchart of determination of whether an exemption condition is satisfied.

### DETAILED DESCRIPTION

In a related example, an electric braking apparatus may convert motor torque generated by motor energization into braking force due to pressing force of a friction pad. The relationship between motor torque and braking force differs between a positive efficiency line when the braking force increases and an inverse efficiency line when the braking force decreases, and has hysteresis characteristics in which the braking force is maintained even if the motor torque changes in a transition from the positive efficiency line to the inverse efficiency line.

According to the related example, a current may be reduced by: generating the braking force slightly higher than target braking force through the positive efficiency line and then reducing the current while maintaining the braking force; and reducing the braking force to the target braking force through the inverse efficiency line. However, in order to maintain the braking force, it is necessary to apply locking energization. When the actuator of the electric brake is provided with a multiphase motor, the current may be concentrated on a particular phase and causes uneven heating. The above situation is not only limited to an electric brake, but may also be common to a multiphase motor that may be controlled by locking energization.

A motor controller according to the present disclosure includes a power converter and a current command calculator.

The power converter converts the input power and supplies alternating current (AC) power to each phase of the multiphase motor. The current command calculator calculates a current command value, defined by a current amplitude and a current phase in the dq-axis coordinate system, for a current to be supplied to the multiphase motor in accordance with a torque command value.

Except when the multiphase motor satisfies a predetermined exemption condition, the current command calculator executes a phase adjustment process that changes a phase of the current command value over time so that the same current flowing to a fixed phase of a motor does not continue for more than a certain period of time during the locking energization while the multiphase motor has stopped rotation.

For example, the current command calculator executes the phase adjustment process by changing the phase of the current on the constant-torque curve or the constant-amplitude circle in the dq-axis coordinate system.

As a result, in the present disclosure, it is possible to prevent heat generation from being concentrated in a particular phase when locking current is applied to the multiphase motor. It may be preferable that the energized phase is changed within a range based on the maximum efficiency operating point, so that the multiphase motor can output torque with high average efficiency.

The following describes multiple embodiments with reference to the drawings. Hereinafter, in the respective embodiments, substantially the same configurations are denoted by identical symbols, and repetitive description will be omitted.

### (Configuration of Electric Brake and Motor Controller)

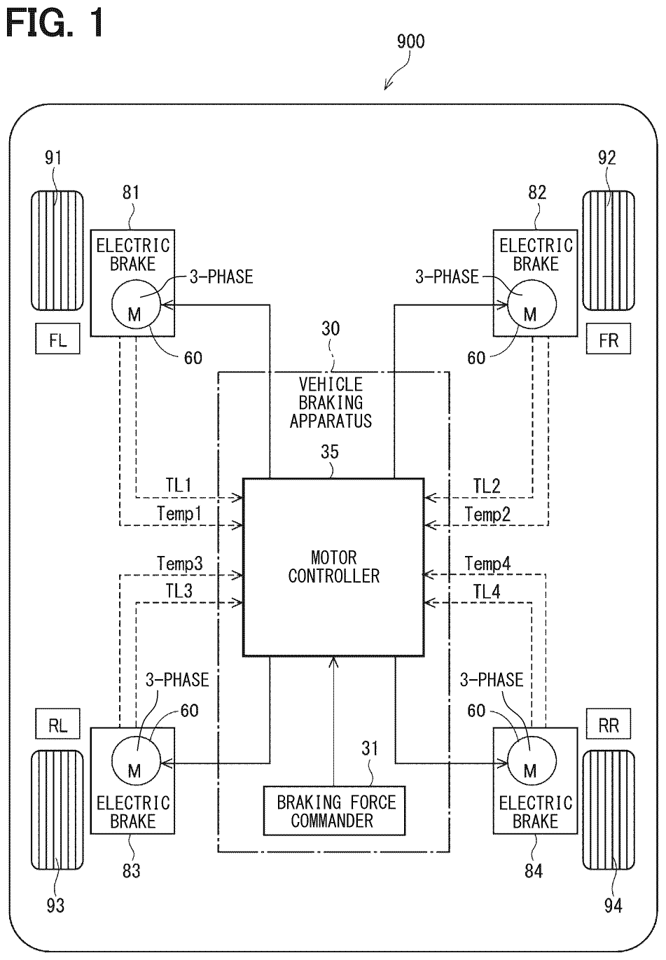

First, a configuration common to each embodiment will be described with reference to FIGS. 1 to 3. As shown in FIG. 1, a vehicle 900 is a four-wheel vehicle having two rows of left and right pairs of wheels 91, 92, 93, 94 in a front-rear direction, and a motor controller 35 is adapted to the vehicle 900. The left and right wheels at the front row may also be noted as “FL” and “FR”, respectively. The left and right wheels at the rear row may also be noted as “RL” and “RR”, respectively.

The electric brakes 81, 82, 83, 84 are provided for the respective wheels 91, 92, 93, 94. In other words, four electric brakes are provided in this example. Hereinafter, four consecutive reference numerals will be appropriately abbreviated to “wheels 91 to 94” and “electric brakes 81 to 84” in some occasions. The same applies to the symbols “load torques TL1 to TL4” and “motor temperatures Temp1 to Temp4” described below.

Each of the actuators of the electric brakes 81 to 84 include a three-phase motor (“3-phase Motor” in the drawing) 60 as a “multiphase motor.” The three-phase motor 60 according to the present embodiment is a permanent magnet-type brushless motor. In this embodiment, the three-phase motors 60 corresponding to the electric brakes 81 to 84 have the same configuration and function. Therefore, a single reference numeral “60” is used. In the following description, the three-phase motor 60 will be abbreviated as simply “motor 60” where appropriate.

The motor controller 35 functions as a part of the vehicle braking apparatus 30. The braking force controller 40 controls the braking force generated by the electric brakes 81 to 84 by controlling a current flowing to each motor 60 in accordance with the braking force commanded by a braking force commander 31. Although FIG. 1 shows a single block as the motor controller 35, it may be shown divided into four blocks corresponding to the motors 60.

Specifically, the ECU included in the vehicle braking apparatus 30 functions as the motor controller 35. The ECU includes, for example, a microcomputer, a pre-driver, and the like, and has a CPU (not shown), a ROM, a RAM, an I/O, and a bus line connecting these components. The ECU performs required control by executing software processing or hardware processing. The software processing may be implemented by causing the CPU to execute a program. The program may be stored beforehand in a memory device such as a ROM, that is, in a readable non-transitory tangible storage medium. The hardware processing may be implemented by a special purpose electronic circuit.

The motor controller 35 may obtain at least one group of a first group of the load torques TL1 to TL4 and a second group of the motor temperatures Temp1 to Temp4. The load torques TL1 to TL4 may be estimated from the power consumption of the inverter. The motor temperatures Temp1 to Temp4 is detected by, for example, a temperature sensor. Alternatively, the motor temperatures Temp1 to Temp4 may be calculated by estimating a temperature rise from Joule heat caused by energizing the three-phase motor 60 and adding the estimated temperature rise to the outside air temperature.

The load torques TL1 to TL4 and the motor temperatures Temp1 to Temp4 will be described later in the explanation of exemption. If not used to determine whether or not the exemption requirements are met, the motor controller 35 does not need to acquire the load torques TL1 to TL4 or the motor temperatures Temp1 to Temp4.

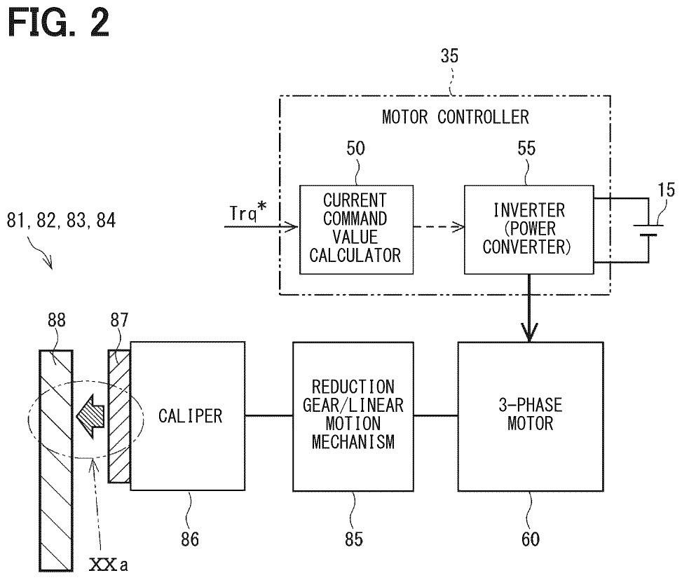

FIG. 2 shows a schematic configuration of the electric brakes 81 to 84 for respective wheels. The motor controller 35 includes an inverter 55 and a current command calculator 50. The inverter 55 corresponds to a power converter. The inverter 55 converts direct current (DC) power provided from a battery 15, and supplies alternating current (AC) power to each phase of the three-phase motor 60. The current command calculator 50 calculates a current command value according to the command torque trq* for a current to be supplied to the three-phase motor 60.

The output torque of the motor 60 operates a pad 87 of a caliper 86 via a reduction gear/linear motion mechanism 85. The pad 87 moves and presses against the disks 88 of each wheel 91 to 94 to generate a braking force through friction. Furthermore, the pad 87 separates from the disk 88, and the braking force is released.

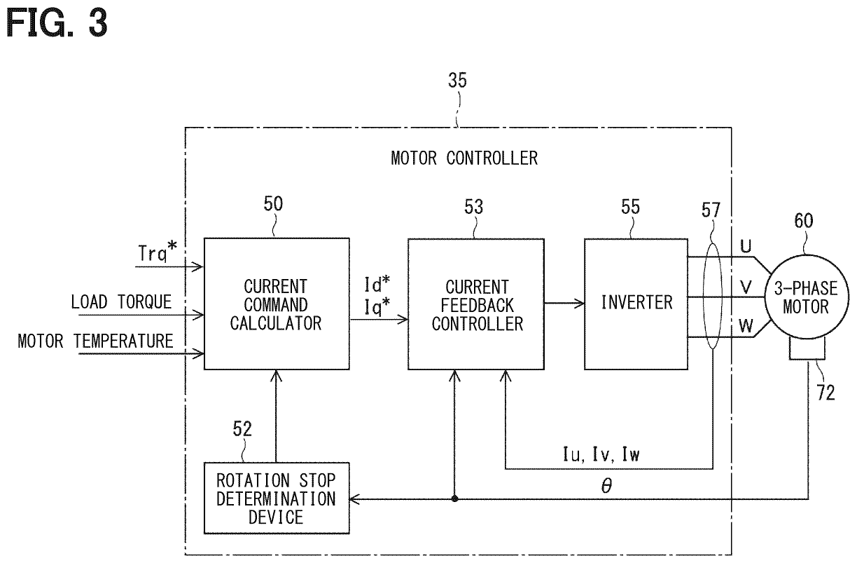

FIG. 3 shows an example of the configuration of the motor controller 35 according to the present embodiment. The motor controller 35 includes a current command calculator 50, a rotation stop determination device 52, a current feedback controller 53, and an inverter 55. The current command calculator 50 calculates dq-axis current command values Id*, Iq* in accordance with the torque command value Trq*, and outputs them to a current feedback controller 53.

The current feedback controller 53 acquires the three-phase currents Iu, Iv, Iw detected by a current sensor 57 and the motor electrical angle θ detected by a rotation angle sensor 72, and converts the three-phase currents Iu, Iv, Iw into d-axis and q-axis currents Id, Iq. The current sensor 57 and the rotation angle sensor 72 are not illustrated in FIG. 1. The current feedback controller 53 calculates a voltage command value so that the dq-axis currents Id, Iq follow the current command values Id*, Iq*, and further generates a gate drive signal and outputs the generated drive signal to the inverter 55.

The rotation stop determination device 52 determines that the rotation of the motor 60 has stopped based on the motor electrical angle θ detected by the rotation angle sensor 72, and notifies the current command calculation unit 50 of the motor 60 has stopped. In addition, “stopped” rotation includes a very low rotation speed state of, for example, about a few rotations per minutes (rpm). Further, the current command calculator 50 obtains the load torques TL1 to TL4 and the motor temperatures Temp1 to Temp4 from the corresponding electric brakes 81 to 84, and determines whether or not the exemption requirements described below are satisfied.

When the corresponding three-phase motor 60 does not satisfy the exemption requirements and the rotation stop determination device 52 determines that the motor is in a stopped rotation state, the current command calculator 50 executes a “phase adjustment process” as described hereinafter.

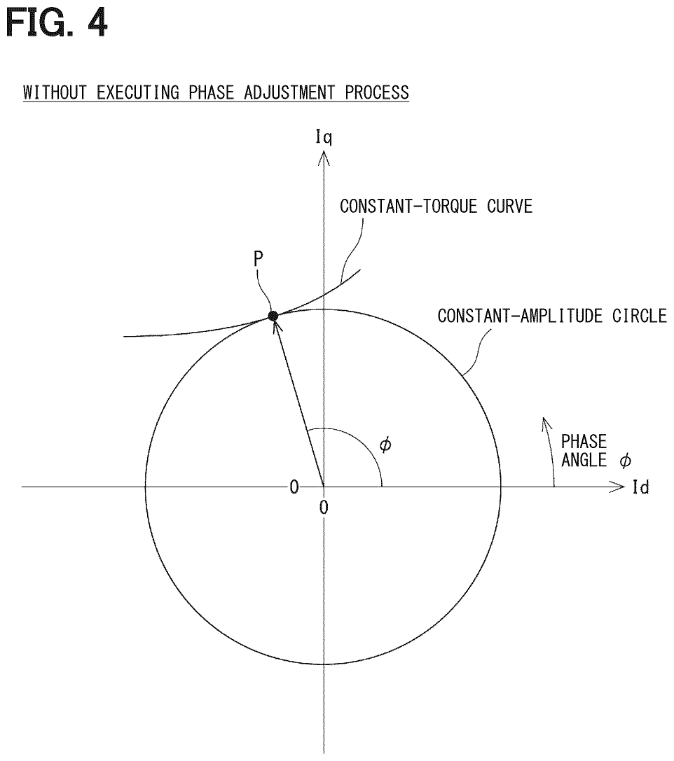

The following describes the setting of the current command value when the phase adjustment process is not performed with reference to FIGS. 4 to 6. As shown in FIG. 4, the current command value is defined by a current amplitude and a current phase in the dq-axis coordinate system. The current amplitude Ia is expressed by the equation (1). The current phase is defined as an angle in the counterclockwise direction with respect to the d-axis. In vector diagrams, the angle is emphasized by expressing it as “phase angle φ,” but “phase angle” has the same meaning as “phase.” In addition, the phase angle may also be referred to as a phase value. The d-axis current Id and the q-axis current Iq are expressed using the phase angle φ as “Id=Ia×cos σ, Iq=Ia×sin φ”.

$$\begin{matrix}[ Equation 1 ] & \\ Ia = \sqrt{{Id}^{2} + {Iq}^{2}} & ( 1 )\end{matrix}$$

The torque τ of the motor 60 is calculated based on the d-axis current Id and the q-axis current Iq using equation (2.1). In the equation, the constant number p is the number of pole pairs, Ke is the magnetic flux of the magnet, Ld is the d-axis inductance, and Lq is the q-axis inductance. By rearranging the equation (2.1) to express the q-axis current Iq as a function of the d-axis current Id, the equation (2.2) for a constant-torque curve is obtained. The constant-torque curve may also be written as a constant torque curve.

$$\begin{matrix}[ Equation 2 ] & \\ τ = pKeIq + p ( Ld - Lq ) IdIq & ( 2.1 ) \\ Iq = \frac{τ}{p \{ Ke + ( Ld - Lq ) Id \}} & ( 2.2 )\end{matrix}$$

The operating point where the current amplitude is minimum on the constant-torque curve is defined as the maximum efficiency operating point P. At the maximum efficiency operating point P, the maximum torque is obtained with the smallest current. In this example, the phase angle φ of the maximum efficiency operating point P is approximately 105°. Hereinafter, the word “approximately” will be omitted from the phase angle φ shown as a numerical example. Note that the phase angle φ at the maximum efficiency operating point P may take a different value depending on the specifications. Moreover, a circle having a radius being equal to the amplitude of the maximum efficiency operating point P is represented as a constant-amplitude circle. The current command calculation unit 50 calculates the dq-axis currents at the maximum efficiency operating point P as current command values Id*, Iq* so that the motor 60 outputs a torque according to the torque command value Trq*. The constant-amplitude circle is a circular path representing a locus of points where the current amplitude is unchanged.

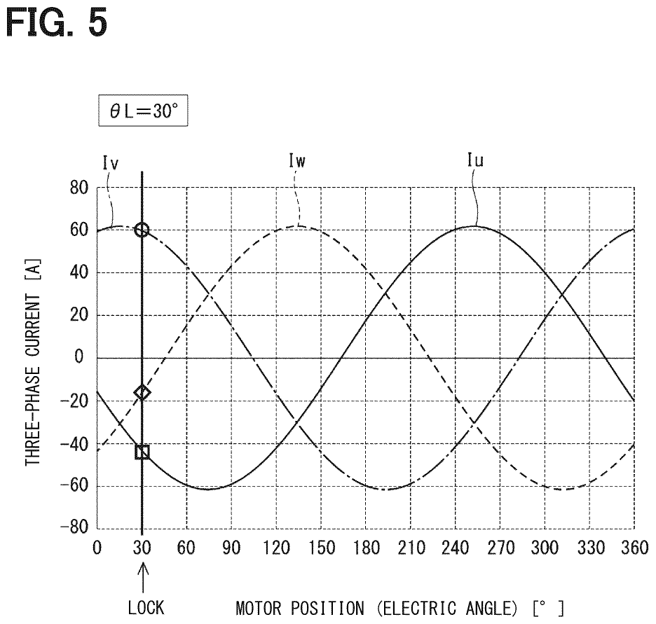

FIG. 5 shows the relationship between the motor position (electrical angle) and the three-phase currents Iu, Iv, and Iw when driven at the maximum efficiency operating point P. The three-phase currents Iu, Iv, and Iw are expressed by equation (3) using the electrical angle θ and the phase angle φ. The units of angles θ and φ are in degrees. The current values on the vertical axis are shown merely for comparison with other figures, and the numerical values themselves have no meaning.

$$\begin{matrix}[ Equation 3 ] & \\ ( \begin{matrix}Iu \\ Iv \\ Iw\end{matrix} ) = \sqrt{\frac{2}{3}} Ia ( \begin{matrix}cos ( θ + φ ) \\ cos ( θ - 120 + φ ) \\ cos ( θ - 240 + φ )\end{matrix} ) = \sqrt{\frac{2}{3}} \{ ( \begin{matrix}cos θ \\ cos ( θ - 120 ) \\ cos ( θ - 240 )\end{matrix} ) Id + ( \begin{matrix}sin θ \\ sin ( θ - 120 ) \\ sin ( θ - 240 )\end{matrix} ) Iq \} & ( 3 )\end{matrix}$$

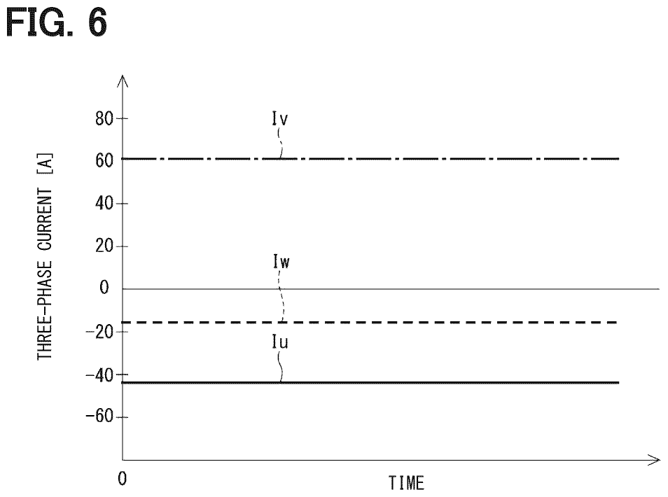

Here, a situation in which the motor 60 is being energized while the motor 60 is stopped is referred to as “locking energization.” For example, when locking current is applied at the stop position θL of an electrical angle of 30°, the current value is in a stable unchanging manner as shown in FIG. 6. In the present disclosure, the term “maximum current” refers to the current with the largest absolute value. When the stop position θL is an electrical angle of 30°, the maximum current flows in the V-phase. Therefore, if the locking current continues to flow, the current may be concentrated in the V-phase, uneven heating may occur. In the notation of the stop position θL, the “electrical angle” will be omitted and it will be expressed as “θL=30°”. In the first embodiment, the condition where the torque is the reference value (=1) and the stop position θL is 30° is represented as “Condition A.”

Therefore, the current command calculator 50 changes the phase of the current command value over time so that the current supply at the same current phase does not continue for a predetermined time or longer during the locking current supply. This process executed in the present embodiment is referred to as a phase adjustment process. Moreover, the phase angle φ before the phase change during locking energization is referred to as the “initial energization phase” or “initial current phase”, and the phase in which the current's absolute value in the initial energization phase is maximum is referred to as the “maximum current phase”. In the example of FIG. 5, the initial energization phase is 105°, and the maximum current phase is the V-phase. Next, a specific method for changing the phase will be described for each embodiment.

### First Embodiment

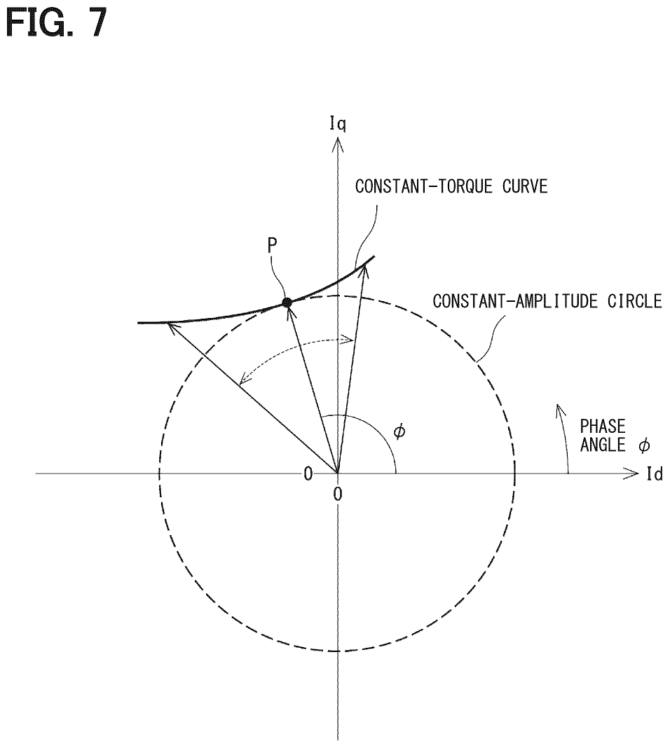

The following describes a phase adjustment process according to a first embodiment with reference to FIGS. 7 to 16. As shown in FIG. 7, the current command calculator 50 changes the phase of the current command value on a constant-torque curve with the maximum efficiency operating point P as a reference. With reference to FIGS. 7 to 9, the general action and effect of the phase adjustment process will be described using condition A where the stop position θL has an electrical angle of 30°.

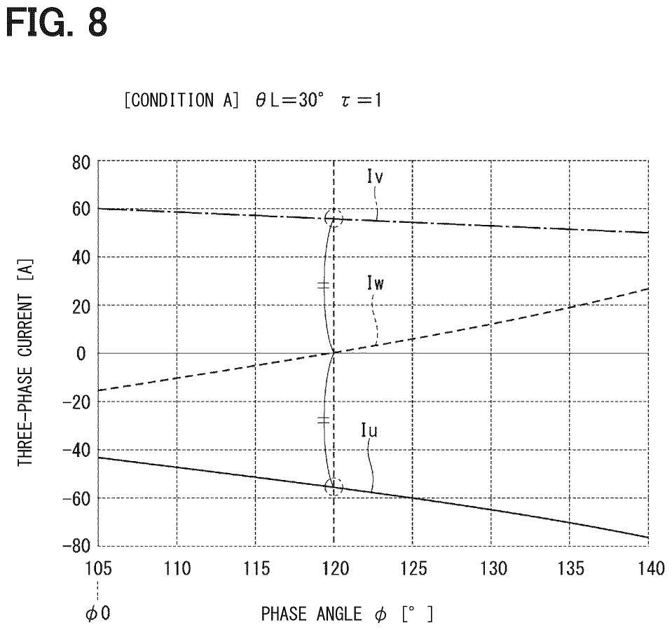

FIG. 8 shows changes in three-phase currents when the phase adjustment process of the first embodiment is executed during locking energization under condition A (stop position)θL=30°. By changing the phase angle φ from the initial energization phase φ0 (105°) Corresponding to the maximum efficiency operating point P to the advance angle side, the current of the maximum current phase (V-phase in this case) can be reduced. When the phase angle φ is 120° (in other words, the phase changing quantity is 15°), the absolute value of the V-phase current Iv and the absolute value of the U-phase current Iu match. When the phase angle φ exceeds 120°, the absolute value of the U-phase current Iu becomes maximum.

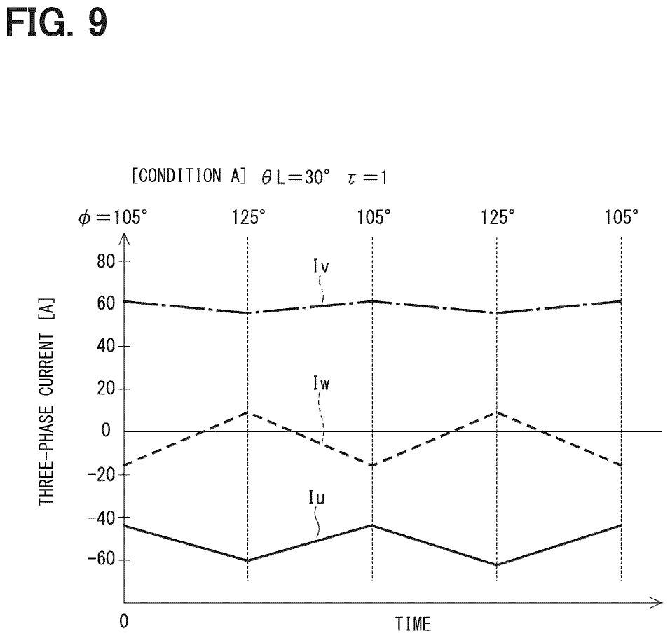

FIG. 9 shows the time change of the three-phase current when the phase angle φ is moved back and forth between 105° and 125° with a phase changing quantity of 20° during locking energization under condition A (stop position θL=30°). In contrast to FIG. 6 in which the phase adjustment process is not executed, the phase currents Iu, Iv, and Iw repeatedly increase and decrease. In this case, the phase through which the maximum current flows can be distributed to the V-phase and the U-phase, so that heat generation in a particular phase of the motor can be suppressed. The method of changing the phase angle φ is not limited to the method of reciprocating within the phase range at a constant speed as shown in FIG. 9, but the phase angle φ may be changed in a stepwise manner at predetermined time intervals. Also, the holding time at each phase angle φ may be differentiated.

In the first embodiment, by changing the phase of the current command value over time, it is possible to prevent current from concentrating on a particular phase and uneven heat generation. By changing the energization phase within a range based on the maximum efficiency operating point P, it is possible to cause the motor 60 to output torque with good average efficiency. In the phase adjustment process on the constant-torque curve, the current amplitude Ia increases as the phase moves away from the maximum efficiency operating point P. Therefore, adjustment may be required in consideration of the increase in current of phases other than the maximum current phase.

Therefore, the relationship between the current amplitude Ia and the phase angle φ will be considered. When the d-axis current Id and the q-axis current Iq in equation (2.1) are expressed by the current amplitude Ia and the phase angle φ, equation (4), which is a quadratic equation for the current amplitude Ia, is obtained.

$$\begin{matrix}[ Equation 4 ] & \\ τ = p ( Ld - Lq ) cos φ sin φ {Ia}^{2} + pKe sin φ Ia & ( 4 )\end{matrix}$$

When equation (4) is solved for Ia in the range of “Ia>0”, equation (5) is obtained when Ld≠Lq and cos φ≠0. Moreover, when Ld=Lq or cos φ=0, the equation (6) is obtained.

$$\begin{matrix}[ Equation 5 ] & \\ Ia = \frac{\sqrt{p \{ {pKe}^{2} sin φ + 4 ( Ld - Lq ) τ cos φ \} sin φ} - pKe sin φ}{2 p ( Ld - Lq ) cos φ sin φ} & ( 5 )\end{matrix}$$

$$\begin{matrix}[ Equation 6 ] & \\ Ia = \frac{τ}{pKe sin φ} & ( 6 )\end{matrix}$$

From equations (5) and (6), the phase angle φ at which the current amplitude Ia is minimum for a certain output torque τ is the initial energization phase φ0 before the phase change, and is uniquely determined. Furthermore, the quantity by which the current amplitude Ia needs to be increased in order to keep the torque τ in an unchanging manner when the energized phase is changed can also be found from equations (5) and (6). When the current amplitude required according to the phase angle φ is expressed as Ia(φ), the first line of equation (3) can be expressed as equation (7).

$$\begin{matrix}[ Equation 7 ] & \\ ( \begin{matrix}Iu \\ Iv \\ Iw\end{matrix} ) = \sqrt{\frac{2}{3}} Ia ( φ ) ( \begin{matrix}cos ( θ + φ ) \\ cos ( θ - 120 + φ ) \\ cos ( θ - 240 + φ )\end{matrix} ) & ( 7 )\end{matrix}$$

Basically, the direction in which the absolute value of the current of the maximum current phase at the operating point of the initial energization phase φ0 decreases is the appropriate phase change direction, and can be uniquely determined from the torque τ and the stop position θL. If this information is mapped, the computational load can be reduced. Similarly, the current value of each phase corresponding to the quantity of phase change is also determined, and the limit value of the phase changing range (in other words, the “adjusted limit phase” or “the adjusted limit current phase” described hereinafter) can be obtained so that the absolute values of the currents of phases other than the maximum current phase do not become excessively large.

In this embodiment, the phase angle (105°) Corresponding to the maximum efficiency operating point P is basically considered to be the initial energization phase φ0, but the same calculation method can be used even if the initial energization phase φ0 is different from 105°. In this case, the current command calculator 50 acquires information on the initial energization phase φ0 and uses the acquired information in the calculation.

Based on the above theory, the current command calculator 50 executes the phase adjustment process as follows. The current command calculator 50 uses at least one of the initial energization phase φ0, the motor stop position θL, and the output torque τ of the motor 60 to determine the direction in which the current's absolute value of the maximum current phase decreases as the phase change direction of the phase adjustment process.

Further, the current command calculator 50 executes the phase adjustment process within a phase changing range from the initial energization phase φ0 to the adjusted limit phase φLIM. Preferably, the current command calculator 50 sets the adjusted limit phase φLIM in a range in which the absolute current values of phases other than the maximum current phase after the phase change are equal to or less than the absolute current value of the maximum current phase before the phase change. However, the adjusted limit phase φLIM may be set based on a different criterion. The adjusted limit phase φLIM may also be referred to as an adjusted limit current phase.

Within the following exemplary range, a “phase other than the maximum current phase” essentially corresponds to the phase with the second largest current's absolute value in the initial energization phase φ0, and is therefore referred to as a “second largest phase” for convenience. If the phase is changed excessively, the absolute value of the current in the second largest phase may increase significantly, or the current reduction effect in the maximum current phase may decrease. Therefore, the phase changing range is set so that the current's absolute value of the second largest phase does not exceed the absolute value of the current of the maximum current phase before the phase change. Depending on the specifications, the phase with the third largest current's absolute value in the initial energization phase φ0 may overtake the second largest current phase during the phase change and become a “phase other than the maximum current phase.”

Here, for the maximum current phase, the absolute value of the current at the initial energization phase φ0 is defined as |Imax0|, and the absolute value of the current at the adjusted limit phase φLIM is defined as | ImaxLIM|. The current's absolute value reduction rate ρ due to the phase change from the initial energization phase φ0 to the adjusted limit phase φLIM is defined by the following equation.

$$ρ = ( \vert Imax 0 \vert - \vert Imax LIM \vert ) / \vert Imax 0 \vert$$

The current command calculator 50 calculates the current's absolute value reduction rate ρ for the maximum current phase using at least one of the initial energization phase φ0, the motor stop position θL, and the output torque τ of the motor 60. When the current's absolute value reduction rate ρ is smaller than a predetermined reduction rate threshold ρth (for example, 2%), that is, when it is determined that the current reduction effect obtained by the phase change does not reach the minimum expected level, no phase change is executed. In this case, the quantity of phase change may be set to zero while maintaining the logic of the phase adjustment process, or the logic of the phase adjustment process itself may be turned off.

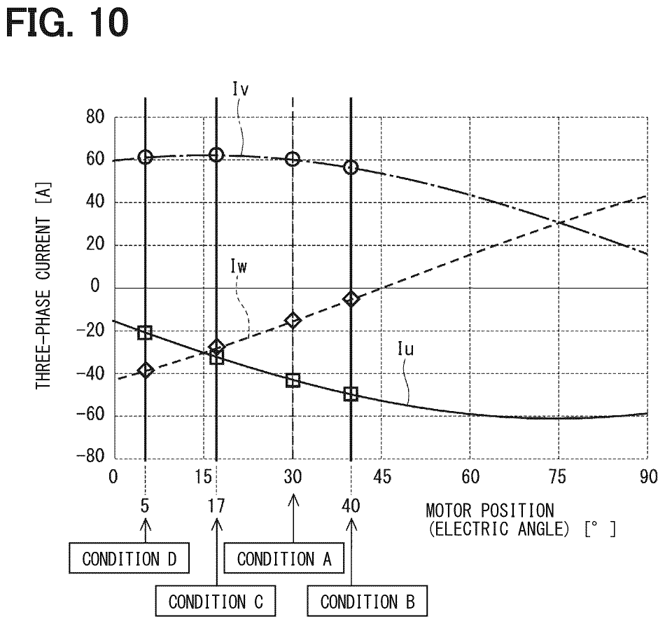

The following describes a specific example of determining the phase change direction and phase changing range in the phase adjustment process in a situation of conditions B to D in which the stop position θL is different in addition to the above condition A (stop position θL=30°). As shown in FIG. 10, the stop position θL in condition B is an electrical angle of 40°; the stop position θL in condition C is an electrical angle of 17°; and the stop position θL in condition D is an electrical angle of 5°. In all of conditions A to D, the maximum current phase is the V-phase. In conditions A to C, the second maximum phase is the U-phase. In condition D, the second maximum phase is the W-phase. The torque τ of the motor 60 is a reference value in [Nm]. The reference torque is represented as “τ=1”.

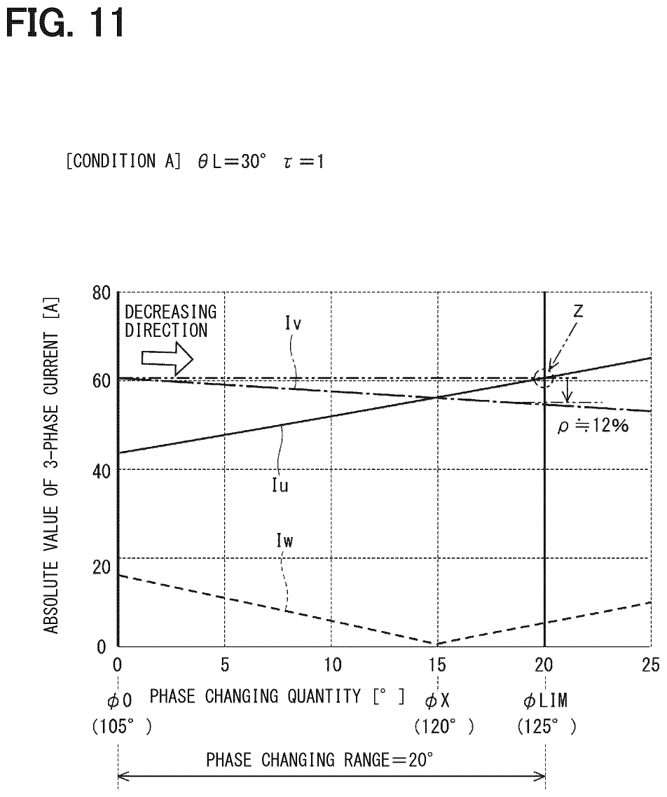

FIG. 11 is a diagram in which FIG. 8 is rewritten for condition A. The horizontal axis represents the quantity of phase change from the initial energization phase φ0, and the vertical axis represents the absolute value of the three-phase current. This makes it easier to grasp the changes in the current's absolute values of the maximum current phase (V-phase) and the second maximum current phase (U-phase) that accompany the phase change. The point at which the absolute value of the current at the second maximum phase reaches the absolute value of the current at the maximum current phase before the phase change is represented as limit point Z. Each of FIGS. 11 to 15 show an example in which the phase of the limit point Z is set to the adjusted limit phase θLIM. In that case, the quantity of phase change is ensured to be maximum.

However, the adjusted limit phase φLIM may be set to a phase before the current's absolute value of the second maximum phase reaches the current's absolute value of the maximum current phase before the phase change. For example, the cross phase φX at which the absolute value of the current at the second maximum phase and the absolute value of the current at the maximum current phase coincide may be set as the adjusted limit phase θLIM. This allows the total loss to be controlled within a smaller range.

Under condition A, the absolute value of the V-phase current Iv decreases in the direction in which the phase angle φ advances from the initial energization phase φ0, and therefore the advance direction is determined as the phase change direction. Further, the phase angle φLIM is set to be the adjusted limit phase, 125°, at which the absolute value of the U-phase current Iu reaches the absolute value of the current at the V-phase before phase change. The phase changing range is set to a range of 20 degrees from a phase angle of 105° being the initial energization phase φ0 to a phase angle of 125° being the adjusted limit phase φLIM. The current's absolute value reduction rate ρ of the V-phase, which is the maximum current phase, is calculated to be approximately 12%. In the following explanation of conditions A to D and AA, if the reduction rate threshold ρth is assumed to be 2%, the current's absolute value reduction rate ρ of approximately 12% is equal to or greater than the reduction rate threshold ρth. Therefore, a phase change is executed. The cross phase φX has a phase angle of 120°.

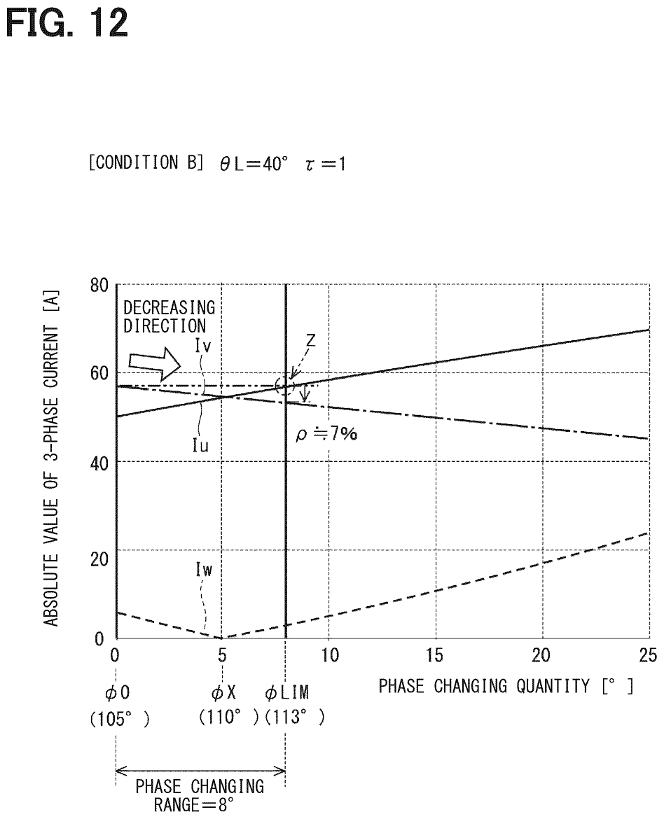

Under condition B (stop position)θL=40° shown in FIG. 12, the phase change direction is the advance angle direction, similar to condition A. Furthermore, in the initial energization phase φ, the difference between the absolute value of the V-phase current Iv and the absolute value of the U-phase current Iu is relatively small. The phase angle 113° at which the absolute value of the U-phase current Iu reaches the current's absolute value before the V-phase phase change is set as the adjusted limit phase φLIM. The phase changing range is set to a range of 8° from a phase angle of 105° to a phase angle of 113°. The current's absolute value reduction rate ρ of the V-phase is calculated to be about 7%, and a phase change is executed. Under condition B, smaller phase changes are repeated in comparison with condition A. The cross phase φX has a phase angle of 110°.

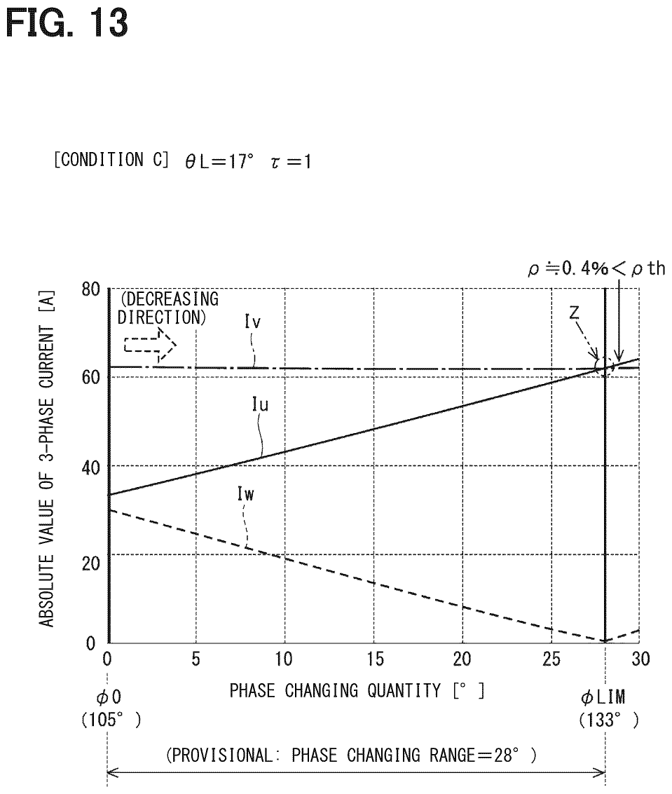

Under condition C (stop position)θL=17° shown in FIG. 13, no phase change is ultimately executed, but the description will be given assuming that the phase change direction and range are provisionally determined in the processing logic. The phase change direction that is provisionally determined is the advance angle direction. The phase angle 133° at which the absolute value of the U-phase current Iu reaches the current's absolute value before the V-phase phase change is set as the adjusted limit phase φLIM. The phase changing range is provisionally set to a range of 28° from a phase angle of 105° to a phase angle of 133°. It is noted that the cross phase φX is omitted since it almost overlaps the adjusted limit phase φLIM.

At this time, the V-phase current's absolute value reduction rate ρ is approximately 0. This is calculated to be 4%. That is, under condition C, even if the phase is changed from the initial energization phase φ0 to the adjusted limit phase φLIM, the absolute value of the V-phase current remains almost in an unchanging manner, and almost no current reduction effect is obtained. Since the current's absolute value reduction rate ρ is smaller than the reduction rate threshold ρth, the current command calculator 50 prevents the phase from being changed.

As in condition C, at a stop position θL being closed to an electrical angle of 15° where the absolute value of the current at the maximum current phase (V-phase) reaches its peak, there may be a large increase in the absolute value of the current at the second maximum phase (U-phase) even though there is almost no current reduction effect due to the phase change. For example, the current command calculator 50 may store the region of the stop position θL where the current's absolute value reduction rate ρ is smaller than the reduction rate threshold ρth in a map, and prohibit phase change at the stop position θL in that region or set the phase changing quantity to zero. Furthermore, the index for evaluating the current reduction effect is not limited to the current's absolute value reduction rate ρ calculated using the above equation, but may be calculated using an equation including, for example, the absolute values of the currents at other phases.

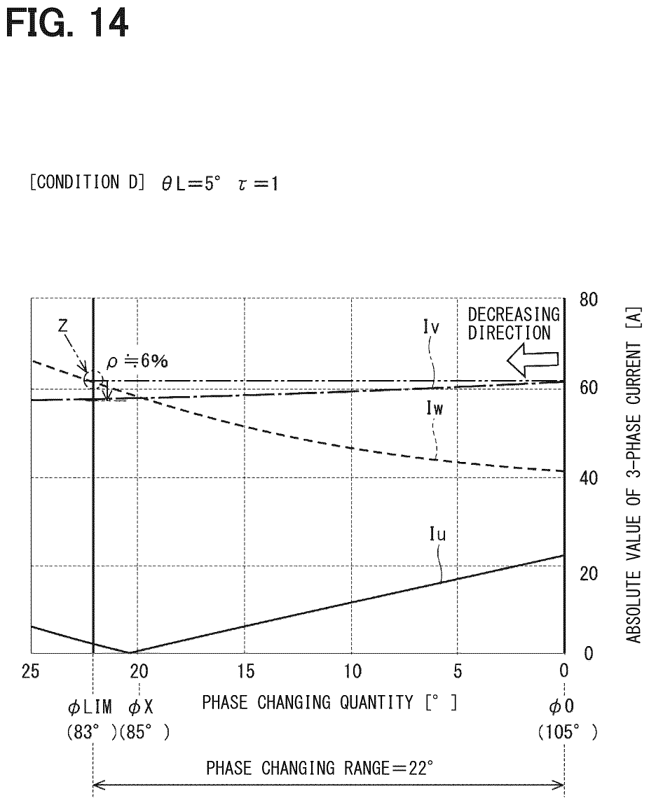

Under condition D shown in FIG. 14 (stop position θL=5°), the absolute value of the V-phase current Iv decreases in the direction in which the phase angle φ is retarded from the initial energization phase φ0, so the retard direction is determined as the phase change direction, contrary to conditions A to C. Further, the phase angle 83° at which the absolute value of the W-phase current Iw, which is the second maximum phase, reaches the absolute value of the current at the V-phase before the phase change is set as the adjusted limit phase φLIM. The phase changing range is provisionally set to a range of 22° from a phase angle of 105° to a phase angle of 83°. The reduction rate ρ of the absolute value of the current at the V-phase, which is the maximum current phase, is calculated to be about 6%, and a phase change is performed. The cross phase φX has a phase angle of 85°.

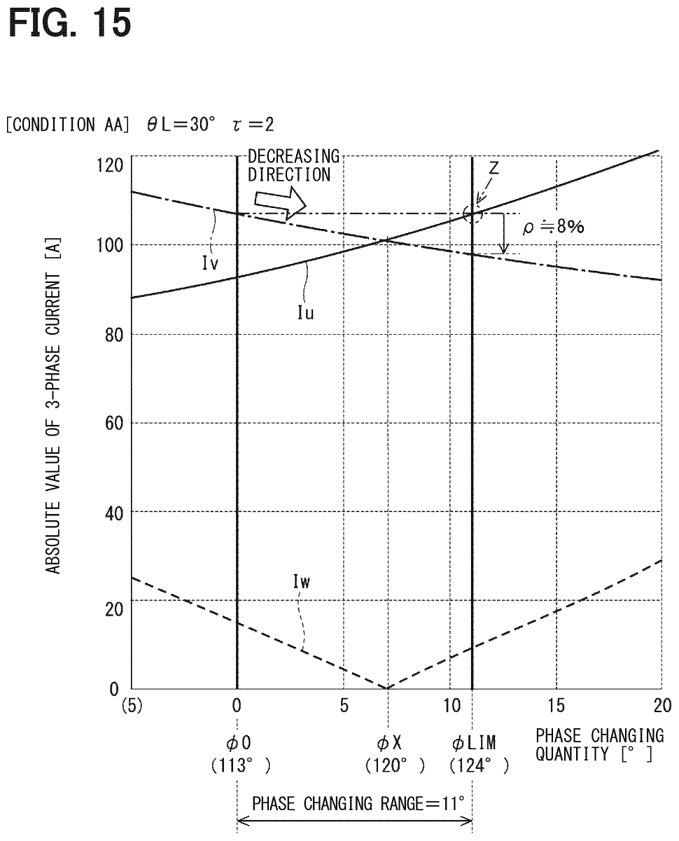

FIG. 15 further shows the relationship between the phase changing quantity and the three-phase current's absolute value under condition AA in which the torque τ is doubled compared to condition A. Under condition AA, the absolute value of the three-phase current is slightly less than twice as large as that under condition A. The initial energization phase φ0, that is, the phase angle φ corresponding to the maximum efficiency operating point P, is 113°. The phase change direction is the advance direction, the same as in condition A. The phase angle 124° at which the absolute value of the U-phase current Iu reaches the current's absolute value before the V-phase phase change is set as the adjusted limit phase φLIM. The phase changing range is set to a range of 11° from a phase angle of 113° to a phase angle of 124°. The reduction rate ρ of the absolute value of the current at the V-phase, which is the maximum current phase, is calculated to be about 8%, and a phase change is executed. The cross phase φX is the same phase angle as in condition A, 120°.

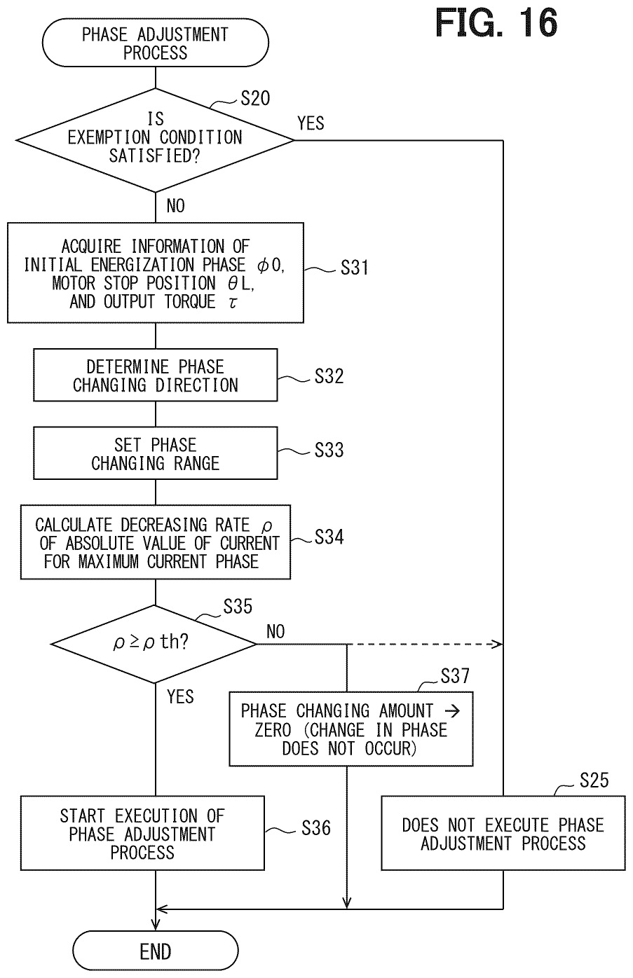

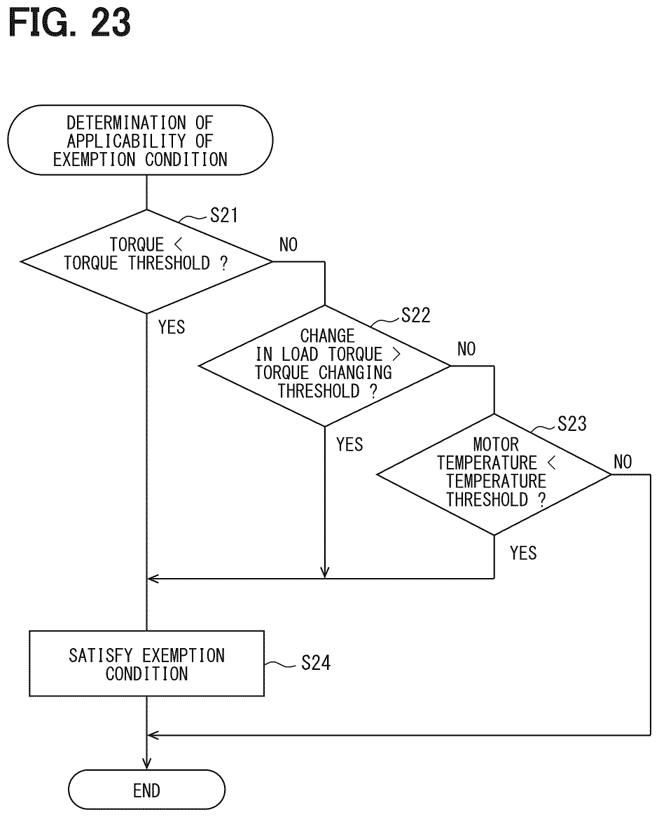

The flow of the phase adjustment process will be described with reference to the flowchart of FIG. 16. In the following flowchart, a symbol S indicates, for example, a step. In S20, it is determined whether the motor 60 satisfies the exemption requirement. The exemption requirement may also be referred to as an application exclusion requirement. A specific example of the exemption requirement will be described later with reference to FIG. 23. If the affirmative determination (YES) is made in S20, the current command calculator 50 does not execute the phase adjustment process in S25, and continues to output the calculated current command values Id*, Iq*.

If the negative determination (NO) in S20, the current command calculator 50 acquires necessary information from among the initial energization phase φ0, the motor stop position θL, and the output torque τ of the motor 60 in S31. The current command calculator 50 uses at least one of the initial energization phase φ0, the motor stop position θL, and the output torque τ of the motor 60 to determine the phase change direction in S32, and sets the phase changing range up to the adjusted limit phase θLIM in S33. In S34, the current command calculator 50 calculates a current's absolute value reduction rate ρ due to the phase change for the maximum current phase.

In S35, it is determined whether the reduction rate ρ of the absolute value of the current is equal to or greater than the reduction rate threshold ρth. If the affirmative determination (YES) is made in S35, the current command calculator 50 starts executing the phase adjustment process in S36. If the reduction rate ρ of the absolute value of the current is smaller than the reduction rate threshold ρth and the negative determination (NO) is made in S35, the current command calculator 50 sets the phase changing quantity to zero in S37, for example, so that no phase change is executed. Alternatively, if the negative determination (NO) is made in S36, as indicated by the dashed arrow, the process may proceed to S25 in the same manner as when the exemption requirement is met.

### Second Embodiment

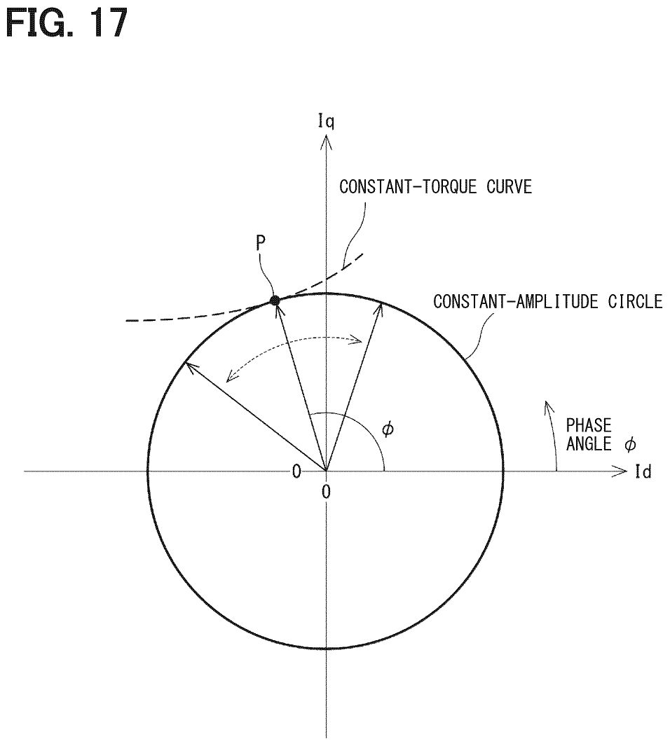

The following describes a phase adjustment process according to a second embodiment with reference to FIGS. 17 to 19. As shown in FIG. 17, the current command calculator 50 changes the phase of the current command value on a constant-amplitude circle with the maximum efficiency operating point P as the reference. The concept of the phase adjustment process is basically the same as the phase change on the constant-torque curve in the first embodiment. In the above equation, the current amplitude Ia is treated as a constant, in other words, an unchanging value that does not change with the phase angle φ.

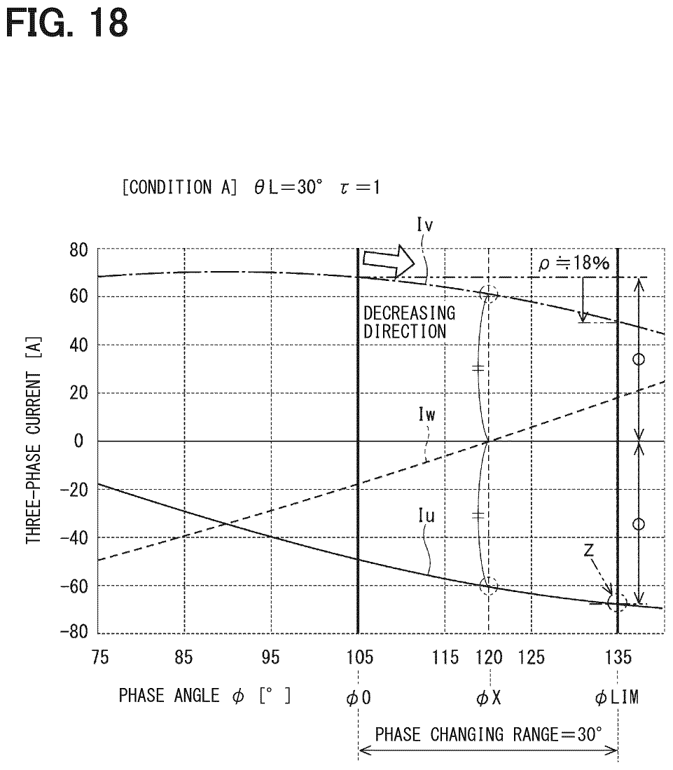

FIG. 18 shows changes in three-phase currents when the phase adjustment process related to the second embodiment is performed during locking energization under condition A (stop position θL=30°, torque τ=1). The advance angle direction in which the current's absolute value of the maximum current phase (V-phase) decreases from the initial energization phase φ0 (105°) Corresponding to the maximum efficiency operating point P is determined as the phase change direction.

Further, the phase angle 135° at which the absolute value of the U-phase current Iu, which is the second maximum phase, reaches the absolute value of the current at the V-phase before the phase change is set as the adjusted limit phase φLIM. The phase changing range is set to a range of 30 degrees from 105° being the initial energization phase φ0 to 135° being the adjusted limit phase φLIM. The reduction rate ρ of the absolute value of the current at the V-phase, which is the maximum current phase, is calculated to be about 18%, and a phase change is executed. The cross phase φX has a phase angle of 120°.

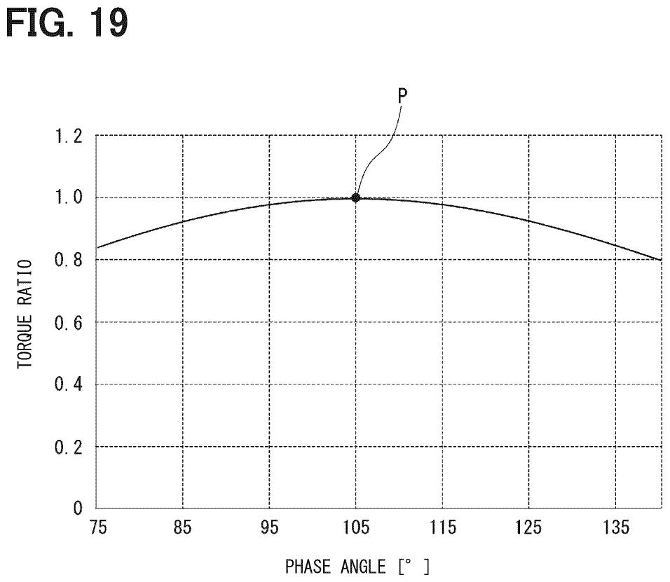

In the second embodiment, similarly to the first embodiment, it is possible to prevent current from concentrating on a particular phase and heat generation from being unevenly distributed. Moreover, the motor 60 can output torque with high average efficiency. However, in the phase adjustment process on the constant-amplitude circle, the current amplitude does not change, but the torque decreases as the phase angle φ moves away from the maximum efficiency operating point P. FIG. 19 shows the change in torque ratio when the torque at the maximum efficiency operating point P is set to 1.

### Third Embodiment

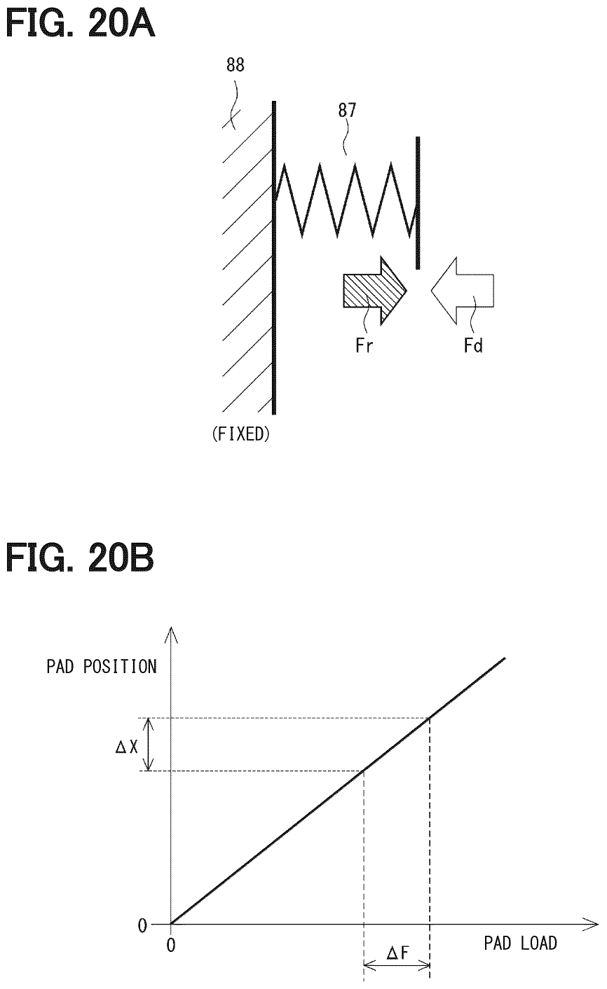

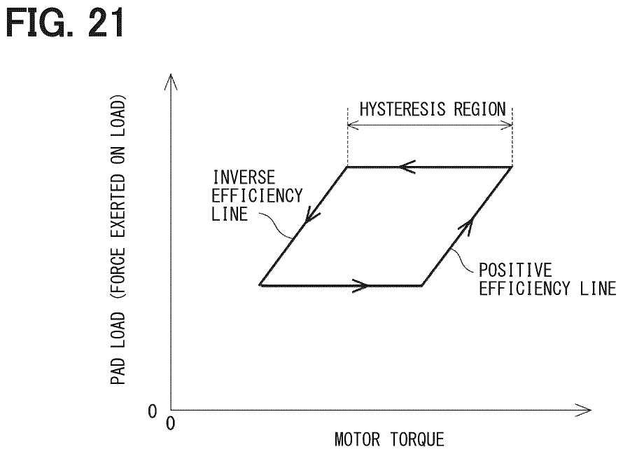

First, with reference to FIGS. 20A, 20B and 21, the characteristics of the pads 87 of the electric brakes 81 to 84 shown in a section XXa of FIG. 2 will be supplemented as a premise for the third embodiment. As shown in FIG. 20A, the pad 87 has spring-like characteristics, and a pressing force Fd by the linear motion mechanism 85 and a reaction force Fr according to the amount of deformation act in opposite directions. As shown in FIG. 20B, the deformation amount (i.e., pad position) X and the pad load F are approximately proportional. Therefore, if the pad position changes by ΔX due to a phase change of the motor 60, the pad load changes by ΔF.

As shown in FIG. 21, the relationship between the motor torque and the pad load has a hysteresis characteristic due to the frictional force of the pad 87. The pad load generated by the positive efficiency line is maintained up to the inverse efficiency line even if the motor torque decreases. Here, the pad 87 and the disk 88 correspond to a load, and the pad load corresponds to a force acting on the load according to the torque of the motor.

The motor controller 35 is applied to a system in which the force acting on a load changes according to the torque of the motor 60. The relationship between the torque of the motor 60 and the force acting on the load has hysteresis characteristics in which the change characteristics of the force acting on the load when the torque of the motor 60 increases is different from the change characteristics of the force acting on the load when the torque of the motor 60 decreases. Under this premise, the current command calculator 50 changes the phase of the current command value within the hysteresis region in the phase adjustment process.

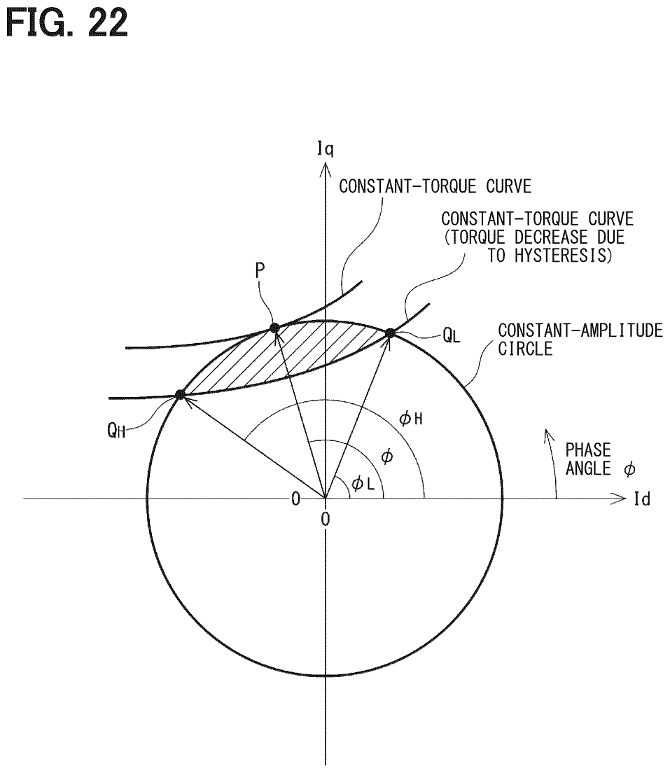

The following describes a phase adjustment process according to a third embodiment with reference to FIG. 22. When the hysteresis characteristic exists, it is possible to maintain the pad load in the region between the original (in other words, high torque side) constant-torque curve and the constant-torque curve on the low torque side obtained by subtracting the torque corresponding to the hysteresis. Moreover, on a constant-amplitude circle passing through the maximum efficiency operating point P on the original constant-torque curve, the current phase can be changed without increasing the current amplitude.

Therefore, the intersection point on the retard angle side between the constant-torque curve on the low torque side and the constant-amplitude circle is designated as QL, and the intersection point on the advance angle side is designated as QH, and the phase angles corresponding to the intersection points QL and QH are designated as φL and φH. The current command calculator 50 may store, for example, a region between the constant-torque curve on the low torque side and the constant-amplitude circle in a map, and select an arbitrary operating point within this region. Further, the current command calculator 50 may change the phase angle φ within the range of phase angles φL to φH on the constant-torque curve on the low torque side. Similarly, in the third embodiment, it is possible to prevent current from concentrating on a particular phase and heat generation from being unevenly distributed. Moreover, the motor 60 can output torque with high average efficiency.

### (Exemption)

In each of the above embodiments, the current command calculator 50 does not necessarily always execute the phase adjustment process, and does not have to execute the phase adjustment process in a situation in which heat generation in a specific phase does not become an issue even if lock current is applied. Therefore, when the motor 60 satisfies the predetermined exemption requirement, the current command calculator 50 does not execute the phase adjustment process, and continues to output the calculated current command value.

An example of whether the exemption requirement is satisfied will be described with reference to the flowchart of FIG. 23. In this example, whether the exemption requirement is satisfied is sequentially determined in steps S21 to S23. It is determined that the exemption requirement is satisfied in step 24 when an affirmative determination (YES) is made in at least one of steps S21 to S23.

As described above with reference to FIGS. 1 and 3, the motor controller 35 acquires the load torques TL1 to TL4 or the motor temperatures Temp1 to Temp4 of the motors 60. In S21, it is determined whether the load torques TL1 to TL4 of the motor 60 are less than a predetermined torque threshold value. In a low load region, the current that flows when the lock current is applied is small, so the heat generation does not cause an undesirable situation.

In S22, it is determined whether the change in the load torque TL1 to TL4 of the motor 60 is greater than a predetermined torque change threshold value. If the affirmative determination (YES) is made in S22, the motor 60 rotates so that the locking energization state is not established in the first place. In S23, it is determined whether the temperatures Temp1 to Temp4 of the motor 60 are less than a predetermined temperature threshold. Even if the locking energization is applied, if there is a sufficient margin for the allowable upper limit temperature, there is no need to perform the phase adjustment process.

In this way, in the situation where locking current is not applied in the first place or where heat generation in a specific phase does not cause an undesirable situation even if locking current is applied, the current command calculator 50 does not execute the phase adjustment process. This makes it possible to avoid an increase in current amplitude as in the first embodiment and a decrease in torque as in the second embodiment at operating points away from the maximum efficiency operating point P, thereby enabling the motor 60 to always operate at maximum efficiency.

### Other Embodiments

The range of change in the current phase in the phase adjustment process is not limited to the situation described in the above embodiment. For example, an adjustment curve that is a compromise between a constant-torque curve and a constant-amplitude circle may be defined, and the current phase may be changed along the adjustment curve.

The number of phases of the motor is not limited to three, but may be a multiphase motor having four or more phases.

The motor controller disclosed present disclosure is not limited to application to motors for electric brakes, and may be applied to any multiphase motor in which heat may be generated unevenly in a particular phase due to the locking energization.

The present disclosure should not be limited to the embodiment described above. Various other embodiments may be implemented without departing from the scope of the present disclosure.

The motor controller and the technique according to the present disclosure may be achieved by a dedicated computer provided by constituting a processor and a memory programmed to execute one or more functions embodied by a computer program. Alternatively, the motor controller and the technique according to the present disclosure may be achieved by a dedicated computer provided by constituting a processor with one or more dedicated hardware logic circuits. Alternatively, the motor controller and the technique according to the present disclosure may be achieved using one or more dedicated computers constituted by a combination of the processor and the memory programmed to execute one or more functions and the processor with one or more hardware logic circuits. The computer program may be stored in a computer-readable non-transitory tangible recording medium as an instruction to be executed by a computer.

A motor controller according to a first aspect may be combined with a motor controller according to a second aspect. In the motor controller according to the first aspect, the current command calculator calculates a current's absolute value reduction rate resulting from a phase change from the initial energization phase to the adjusted limit phase for a maximum current phase in which a current's absolute value in the initial energization phase is maximum, using at least one of an initial energization phase, a motor stop position, and an output torque of the motor during the locking energization. When the current's absolute value reduction rate is smaller than a predetermined reduction rate threshold, the first motor controller does not execute phase change. In the motor controller according to the second aspect, the current command calculator uses at least one of the initial energization phase during the locking energization, the motor stop position, and the output torque of the multi-phase motor to set the adjusted limit phase in a range in which the absolute current value after phase change of a phase other than the maximum current phase is equal to or less than the absolute current value before phase change of the maximum current phase in which the absolute current value in the initial energization phase is maximum.

A motor controller according to a third aspect may be combined with any other motor controller described in the present disclosure. In the motor controller according to the third aspect, the current command value calculator continues to output the calculated current command value without executing phase adjustment process, in a case where at least one of exemption requirements is satisfied. The exemption requirements include that: the load torque of the multiphase motor is less than the predetermined torque threshold; the changing quantity in the load torque of the multiphase motor is larger than the predetermined torque changing threshold value; and the temperature of the multiphase motor is less than the predetermined temperature threshold.

The present disclosure has been made in accordance with the embodiments. However, the present disclosure is not limited to such embodiments and configurations. The present disclosure also encompasses various modifications and variations within the scope of equivalents. Furthermore, various combination and formation, and other combination and formation including one, more than one or less than one element may be made in the present disclosure.

What is claimed is:

1. A motor controller comprising:
a power converter configured to supply alternating current power to each phase of a multiphase motor by converting input power of the power converter; and
a current command calculator configured to calculate a current command value for a current supplied to the multiphase motor based on a torque command value, the current command value being defined by a current amplitude and a current phase in a dq-axis coordinate system, wherein:
the current command calculator is further configured to execute a phase adjustment process in a case where the multiphase motor is in a locking energization state in which the multiphase motor is being energized while the multiphase motor has stopped rotation, except when the multiphase motor satisfies a predetermined exemption condition; and
the phase adjustment process is a process in which a change in the current phase of the current command value is executed over time to prevent the multiphase motor from being energized with same current phase for a predetermined time or longer.

2. The motor controller according to claim 1, wherein:
the current command calculator is further configured to execute the change in the current phase of the current command value upon a constant-torque curve in the dq-axis coordinate system in the phase adjustment process.

3. The motor controller according to claim 1, wherein:
the current command calculator is further configured to execute the change in the current phase of the current command value upon a constant-amplitude circle in the dq-axis coordinate system in the phase adjustment process.

4. The motor controller according to claim 1, wherein:
the multiphase motor includes a maximum phase having a largest absolute current value among phases of the multiphase motor at time of energization of the multiphase motor with an initial current phase of the current command value;
the initial current phase is an initial phase value of the current phase during the locking energization state; and
the current command calculator is further configured to determine a decreasing direction of an absolute current value of the maximum phase as a phase changing direction in the phase adjustment process based on at least one of
the initial current phase,
a stop position of the multiphase motor, and
an output torque of the multiphase motor.

5. The motor controller according to claim 1, wherein:
the current command calculator is further configured to adjust the current phase of the current command value within a phase changing range spanning from an initial current phase of the current command value to an adjustment limit current phase of the current command value in the phase adjustment process; and
the initial current phase is an initial phase value of the current phase during the locking energization state.

6. The motor controller according to claim 5, wherein:
the multiphase motor includes a maximum phase having a largest absolute current value among phases of the multiphase motor at time of energization of the multiphase motor with the initial current phase; and
the current command calculator is further configured to set the adjustment limit current phase within a range in which an absolute current value of a phase other than the maximum phase after the change in the current phase of the current command value is equal to or smaller than the largest absolute current value before the change in the current phase of the current command value, based on at least one of
the initial current phase,
a stop position of the multiphase motor, and
an output torque of the multiphase motor.

7. The motor controller according to claim 5, wherein:
the multiphase motor includes a maximum phase having a largest absolute current value among phases of the multiphase motor at time of energization of the multiphase motor with the initial current phase of the current command value;
the current command calculator is further configured to calculate a reduction rate of the largest absolute current value of the maximum phase due to the change in the current phase from the initial current phase to the adjustment limit current phase, based on at least one of
the initial current phase,
a stop position of the multiphase motor, and
an output torque of the multiphase motor; and
the current command calculator is further configured not to execute the change in the current phase of the current command value, based on a condition that the reduction rate is smaller than a predetermined reduction threshold rate.

8. The motor controller according to claim 1, wherein:
the motor controller is configured to be adapted to a system in which a force acting on a load changes according to a torque of the multiphase motor;
a relationship between the force acting on the load and the torque of the multiphase motor exhibits hysteresis characteristics in which a change in the force acting on the load during an increase in the torque of the multiphase motor is different from a change in the force acting on the load during a decrease in the torque of the multiphase motor; and
the current command calculator is further configured to execute the change in the current phase of the current command value within a hysteresis region corresponding to the hysteresis characteristics in the phase adjustment process.

9. The motor controller according to claim 1, wherein:
the predetermined exemption condition includes a first requirement, a second requirement, and a third requirement;
the first requirement is a requirement in which a load torque of the multiphase motor is smaller than a predetermined torque threshold;
the second requirement is a requirement in which a changing quantity of the load torque of the multiphase motor is larger than a predetermined torque changing threshold;
the third requirement is a requirement in which a temperature of the multiphase motor is lower than a predetermined temperature threshold; and
the current command calculator is further configured to continue outputting the current command value without executing the phase adjustment process, based on a condition that the multiphase motor satisfies at least one of the first requirement, the second requirement, or the third requirement.

10. A method for controlling a multiphase motor, the method comprising:
calculating a current command value for a current supplied to the multiphase motor based on a torque command value, the current command value being defined by a current amplitude and a current phase in a dq-axis coordinate system; and
executing a phase adjustment process in a case where the multiphase motor is in a locking energization state in which the multiphase motor is being energized while the multiphase motor has stopped rotation, except when the multiphase motor satisfies a predetermined exemption condition,
wherein the phase adjustment process is a process in which a change in the current phase of the current command value is executed over time to prevent the multiphase motor from being energized with same current phase for a predetermined time or longer.
